(19) United States
(12) Patent Application Publication
(10) Pub. No.: US 2007/0264472 A1
(43) Pub. Date: Nov. 15, 2007

(54) Sandwich Panel and a Method of Producing a Sandwich Panel

(76) Inventors: Elena Bozhevolnaya, Aalborg (DK); Ole Thybo Thomsen, Stovring (DK); Leif Jakobsen, Aalborg (DK); Anders Lyckegaard, Aalborg (DK)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/580,421

(22) PCT Filed: Nov. 24, 2004
(86) PCT No.: PCT/DK04/00813

§ 371 Date: Mar. 28, 2007

(30) Foreign Application Priority Data
Nov. 24, 2003 (EP) 03027020.1

(51) Int. Cl. E04C 2/34; B32B 15/08; B32B 3/18

(52) U.S. Cl. 428/156; 156/295

(57) ABSTRACT

The present invention relates to a sandwich panel comprising a front face plate, a back face plate and one or more core materials, where said front face plate and said back face plate are interconnected by said core materials, where a number of different core inserts, and/or fasteners are provided in connection to said sandwich panel, where boundaries between said core inserts and/or fasteners and said core material terminate at an angle, preferably of 90 degrees, in relation to said face plates, and/or where a number of joints, shaped by complementary surfaces of said core materials, terminate at an angle, preferably of 90 degrees, in relation to said face plates, wherein said core materials and/or said core inserts are provided with a structural grading and/or shaping of said boundaries and/or said joints The present invention furthermore relates to a method for producing such a sandwich panel.

### BACKGROUND OF THE INVENTION

1. Field of the Invention

The present invention relates to a sandwich panel comprising a front face plate, a back face plate and one or more core materials, where said front face plate and said back face plate are interconnected by said core materials, where a number of different core inserts, and/or fasteners are provided in connection to said sandwich panel, where boundaries between said core inserts and/or fasteners and said core material terminate at an angle, preferably of 90 degrees, in relation to said face plates, and/or where a number of joints, shaped by complementary surfaces of said core materials, terminate at an angle, preferably of 90 degrees, in relation to said face plates.

The present invention furthermore relates to a method for producing a sandwich panel.

Sandwich panels are used in any area where it is important to obtain a high weight-to-strength ratio, for example for the manufacturing of ships, airplanes, automotive vehicles or buildings.

### DESCRIPTION OF THE PRIOR ART

From U.S. Pat. No. 5,589,243 a rigid foam board is known, where absorptive fibrous web sheets are adhered to core panels such that the core is engaged by said web sheets. In order to connect the two absorptive web sheets on either side of the core, web sections going from one web sheet to the opposite web sheet through the core are provided. The web sheets may be adhered to the core material in a number of ways, and for example the connection between the surface web sheets and the web sections going through the core may be improved by providing fillets, i.e. cut off sections of the core materials, in the surface where the web sheet connects to the surface web sheet such that as an adhesive is forced into the absorptive fibrous web, the fillet will be filled with this adhesive and thereby create a stronger connection.

From U.S. Pat. No. 2,578,781 a method of manufacturing a porous plywood is known, where veneer sheets are adhesively bonded with the grains in different directions in order to create relatively strong skin. Two sheets of adhesively bonded veneer sheets are placed on either side of a core, where the core consists of panel shaped elements.

The advantage of a sandwich panel is that it comprises stiff front and back panels, which are interconnected with a light core material of possibly varying thickness, whereby the sandwich panel obtains strength and stiffness equal to that of a solid plate, but with reduced weight in comparison to a solid plate of the same physical dimensions.

Further optimization of the strength-to-weight and stiffness-to-weight ratios, whereby the functionality of the sandwich panel is significantly increased, is impossible without the use of different core materials with various densities in the same sandwich panel.

The use of one or more core materials may cause problems with the strength of the sandwich panel in the joint section between two different core materials, and therefore it is necessary to provide means for connecting said two different core materials.

To use a sandwich panel efficiently in a construction, it is necessary to provide for example fasteners for attachment or rigging purposes for different appliances, such as engines, masts, cable ducts, etc.

These appliances are typically influenced by for example pressure, tractions or vibrations, which will be transferred into the sandwich panels and transformed into shear forces at the boundaries between the core inserts and the core materials, or at the joints between different core materials.

The shear forces inevitably cause local stresses in the adjoining materials at the boundaries. These stresses are induced by the presence of material discontinuities, and they are proportional to the ratio of the shear moduli of the adjoining materials.

Thus, the larger the difference between the elastic properties of the adjoining materials is, the higher are the additional local stresses in the vicinity of the joint. This may seriously jeopardize the structural integrity of the whole sandwich assembly.

Sandwich structures easily fail when subjected to concentrated loads whereby local bending effects are induced in the vicinity of points of geometric and material discontinuities.

The reason for this is that, although sandwich structures are well suited for the transfer of overall bending and shearing loads, localized shearing and bending effects induce severe through-thickness shear and normal stresses in the core material.

These through-thickness stress components can be of significant magnitude, and may in many cases approach or exceed the allowable stresses in the core material as well as in the interfaces between the core and the face sheets.

Accordingly, it is necessary to use for example core inserts, stiffeners or backing plates to avoid premature failure of the soft core materials, as well as to redistribute the external shear load over a larger area of the sandwich panel, thereby locally reducing the induced stresses at the boundaries between adjoining materials.

This will ensure that the core inserts and/or joints can comply with the stresses without damaging the core material.

In the known and conventional designs of sandwich panels, described in for example the Japanese patent application JP 200-282652, an insert is provided with a backing plate as well as a fading out of a sandwich plate to a monolith, where the boundaries between the core material and inserts are at 90 degrees angles relative to the front and back plates, and where the back plate distributes the strains from the connection member to the sandwich panel.

Because of the 90 degrees angles of the boundaries between the core material and the inserts relative to the front and back plates, the shear forces are high and the strengths of the boundaries are relatively low. Thus, there is risk that the traction or pressure forces applied will cause damage and eventually complete failure of the sandwich panel.

In the British patent GB 2017857 an insert is shown with flanges at the front and back plates. The disadvantage of this design is that any pressure or traction will increase the risk for compressing and deforming the boundaries of the core material, whereby the strength of the construction around the insert is reduced.

### SUMMARY OF THE INVENTION

The present invention provides a sandwich panel with a high weight-to-strength ratio, where joints in the core material and the core inserts are formed to provide enhanced strength against any external traction or pressure force applied by enlarging the transition zones of the resulting shear forces in the joints or boundaries of the core materials. This is obtained with a sandwich panel wherein the core materials and/or the core inserts are provided with a structural grading and/or shaping of said boundaries and/or said joints.

The present invention also provides a sandwich panel with different types of boundaries and/or joints between adjacent core materials. This is obtained with a sandwich panel wherein the core materials and/or the core inserts are provided with a structural grading and/or shaping of the boundaries and/or the joints. This is furthermore obtained with a sandwich panel wherein the boundaries and/or the joints, at least on one part, terminate at an angle different from 90 degrees in relation to the face plates. And equally obtained with the second objective is a sandwich panel wherein the angle is varied throughout the thickness of the core materials and/or the core inserts.

Third, the present invention provides a sandwich panel with core materials and/or core inserts with different material stiffness. This is obtained with a sandwich panel wherein the core materials and/or the core inserts are provided with a number of apertures.

Fourth, the present invention provides a sandwich panel, where a patch substitutes a part of the core material either at the upper or lower parts of a joint, and thereby locally reinforces the face plates and thus suppresses severe local stresses in the core in the vicinity of joints. This is obtained with a sandwich panel wherein the core material furthermore comprises one or more patch cores, and where boundaries between the patch cores and the core material terminate at an angle different from 90 degrees in relation to the face plates. And further obtained with the fourth objective is a sandwich panel wherein the joints of the core materials are provided with one or more reinforced patches that are connected to one of either the face plates.

Fifth, the present invention provides a sandwich panel with reinforced monoliths. This is obtained by a sandwich panel wherein the fading out of the sandwich panel to a monolith is provided with a stiffer core/core patch with a sharpening of the boundaries.

Furthermore, the present invention provides a method for producing a sandwich panel. This is obtained by a method comprising the following steps:
a) either the front face plate or the back face plate are positioned with an outer surface downwards;
b) the upwards facing surface of the face plate is provided with an adhesive
c) the core materials or the core inserts or the patch cores or a combination of these are placed upon the upwards facing surface and adhered together;
d) the upwards facing surface of the core materials or the core inserts or the patch core or a combination of these is provided with an adhesive;
e) the front face plate or the back face plate is positioned upon the upwards facing surface,
f) the whole sandwich panel is pressed together.

In the following:
a joint is an area where either complementary surfaces of two different adjoining core materials of dissimilar elastic properties are adjoined, or complementary surfaces of the same core materials are adjoined with an adhesive component;
a boundary is an area where complementary surfaces of adjoining core materials and core inserts are adjoined with an adhesive component;
a fastener is a structure attached to the sandwich plate, wherein an external component can be attached to the sandwich panel;
a core insert is a piece of a stiff core, plywood, wood, polymeric material, metal or the like, which substitutes a part/amount of the original core in the sandwich panel with the purpose of achieving a local reinforcement of the panel in order to introduce external transverse loads via fasteners. In the literature, the core insert is often called a stiffener or a backing/reinforcing plate;
a reinforcing patch is an excessive amount of adhesive or glue or some polymeric compound (liquid during the production phase), which substitutes part of the core at the upper and lower parts of the joint bordering with the front and back face plates, and thereby locally reinforces the face plates and thus suppresses severe local stresses in the core in the vicinity of joints;
a through-the-thickness insert is an insert penetrating the sandwich panel, wherein an external component can be attached to the sandwich panel; and
a fading out of the sandwich plate to the monolith is a gradual decrease of the core thickness until it reaches zero and the front and back plates meet.

All sandwich panels are designed with a front plate, a back plate and at least one core material. If the sandwich panel is provided with more than one core, it is possible that some core parts are made of different materials with different materials properties, such as elasticity, density and the like.

Because the fasteners are influenced by for example pressure, tractions or vibrations, they are attached to the sandwich panel in areas with core inserts, stiffeners, backing plates, filler cavities or patch cores, which all have an enhanced strength in comparison to the soft core material.

To redistribute the external shear load onto the large area of the sandwich panel, the core material is designed with a structural grading of the core material and/or a structural shaping of the core material.

To ensure the strength of the sandwich panel in areas with boundaries or joints, it is necessary that the shape of the surfaces of the core insert or core material is complementary to the shape of the surfaces of the adjoining core insert or core material, thereby ensuring a tight fastening of the fasteners to the sandwich panel.

Gaps are not allowed between the core insert and the adjoining core material, since it will immediately lead to failure of the structure even at very small loads.

Where the sandwich panels are joined, there will be a joint between the core materials of the two sandwich panels. To increase the strength of the joint, and to prevent the occurrence of premature failure, the joint is designed with a structural shaping, or the core material is provided with a structural grading.

A structural grading of the core material is for example a graded change of the elastic properties extending from the borders and into the interior of the core material.

A structural shaping of the core material is for example where the boundary of the core material has a specific linear or curved shape or a combination of these shapes.

It is known that there is a high risk of preliminary and highly undesirable structural failure of sandwich panels where two adjacent materials are joined with a boundary/joint terminating at 90 degrees in relation to the face plate.

The reason is that, at the boundaries/joints, the external transverse (shear) loads transform into internal shear forces in the core material, thereby giving rise to local stresses induced by the presence of the material discontinuities near the boundary/joint.

A fading out of the sandwich plate to the monolith, where the thickness of the core material decreases until the front and back plates of the sandwich panel meet, is equal in physical parameters to a core material provided with a structural grading and/or shaping of the boundaries and/or joints between adjacent core materials and/or adjacent core inserts.

In one embodiment of the present invention, the boundaries and/or the joints, at least on one part, terminate at an angle different from 90 degrees in relation to the face plates.

The part of the boundaries or joints having an angle different from 90 degrees in relation to the face plates will increase the transition zone for the resulting shear force, and, consequently, reduce the magnitude of the additional local stresses induced near the joints due to the material discontinuity. Thereby the strength of the boundaries or joint is significantly increased.

In a second embodiment of the present invention, the angle is varied throughout the thickness of the core materials and/or the core inserts. This provides a smoother distribution of the elastic properties of the adjoining materials and lower local stresses at the boundaries.

The joints or boundaries can have a curved form or be an assembly of straight lines with angles different from 90 degrees relative to the face plates or a combination of both.

If the joint or boundary is V-formed, any angle of the joint/boundary will improve the stress distribution at the joint/boundary. The connecting acute angle has the effect that as the angle becomes sharper, there will be a pronounced favorable effect on the joint/boundary.

However, very sharp angles should be avoided because sharp noses of soft cores may fail and be impractical in production. A recommended interval of the angle is 30-75 degrees

In a third embodiment of the invention, the core materials and/or the core inserts are provided with a number of apertures that provide the boundary area with smoothly varying material properties such as elasticity.

The apertures can be microscopic circular holes machined in the stiff material and situated transversely or in-plane, parallel to the boundaries in the case of rectangular core inserts, and transversely along the radii in the case of circular core inserts.

The apertures provide the boundary with gradually varying elastic properties of the stiff core material towards the boundary, and this smoothens the local stresses appearing in the transition zone between the two different materials, and increases the strength of the joints/boundaries.

The size of the aperture should be larger than the characteristic size of the pores of the core material, and sufficiently smaller (approximately 10 times) than the characteristic size of the sandwich panel (same thickness of the core material).

Preferably the form of the aperture is cylindrical, but it may alternatively be polygonal.

In a further embodiment of the invention, the core material furthermore comprises one or more patch cores, where the boundaries between the patch cores and said core material terminate at an angle different from 90 degrees in relation to the face plates.

The practical purpose of using patch cores is to diminish material discontinuity at the border between two materials with different elastic properties. Any difference in the elastic properties causes local effects at the border that manifest themselves in an abrupt rise of local stresses in the face plates, as well as in the core material near the joint.

The larger the difference in elastic properties is, the more severe these local stresses will be. Introducing a patch core with intermediate elastic properties leads to a smoothening of the material discontinuities, and consequently the local effects are reduced in magnitude near the boundary.

In an another embodiment of the invention, the joints of the core materials are provided with one or more reinforced patches that are connected to one of the face plates.

A reinforced patch substitutes part of the core at the upper and lower parts of the joint border with the front and back face plates and thereby locally reinforces the face plates. Thus it suppresses devastating local stresses in the core in the vicinity of the joints.

In yet an another embodiment of the invention, one or more through-the-thickness inserts are provided for penetrating sandwich panel, and here boundaries between said through-the-thickness inserts and core material terminate at an angle different from 90 degrees in relation to face plates.

In yet another embodiment of the present invention, where the sandwich panel is fading out to a monolith, the original core material will in a vicinity of the monolith be substituted with a core material of higher stiffness and/or of shaped junctions in order to provide a smother transition zone between the sandwich panel and the monolith (the situation where front and back plates meet).

The invention can be used in connection with joints between different core materials in a sandwich panel, or backing plates used for the implantation of fasteners, or rigid metallic or polymeric material through-thickness inserts, or filled cavities used for the implantation fasteners or in the part of the sandwich panel, where it transforms into the monolith.

There is no limitation to the thickness of the sandwich panel with regard to the considered problem of the core joints. A sandwich panel has a definite ratio between the thickness of the faces and the core, typically in the range t_{face}/t_{core}˜⅕- 1/10, but the absolute thickness of the panel is of no significance.

Sandwich panel thicknesses in practice may range from a few millimeters (for instance in spacecraft applications) up to 0.3-0.4 meters (in some building applications). The complementary thicknesses of face plates observed in practice lie in the range from tenths of millimeters to several centimeters, depending on the specific application.

Core thicknesses may in practice range from a few millimeters to 0.3-0.4 meters, again depending on the specific application. Irrespective of the particular application, for example aerospace, marine, or automotive applications, and irrespective of the specific panel thicknesses or other characteristic parameters, inserts are widely used in order to accommodate fittings, fasteners, etc.

As such, the invention can be used in any construction/application or structural assembly involving sandwich panels/structures, that is in any construction/application or structural assembly where it is necessary to obtain high strength-to-weight ratios as well as high stiffness-to-weight ratios.

Sandwich structures are already successfully used for a variety of structural load-carrying applications such as spacecrafts, aircrafts, trains, cars/trucks, wind turbine blades, boat/ship superstructures, boat/ship hulls, civil engineering structures such as bridges and buildings, cargo containers (including refrigerated containers), and many others.

Common to the aforementioned applications is that the severe requirements with regard to low structural weight, and at the same time very high stiffness and strength properties, derive from or are accompanied by requirements regarding low energy/fuel consumption, crash worthiness and passenger safety, high resistance against buckling, high resistance against corrosion, thermal insulation capacity and thermal directivity, high dampening and energy dissipation capacity, fire resistance, etc.

The potential for the application of sandwich panels/structures for other than the applications mentioned is tremendous, and among specific potential applications, the following should be mentioned:
furniture, such as tables, shelves, room dividers, cupboards, etc.
kitchen appliances, such as a freezers, coolers, cooling boxes, etc.
solar panels
fixed wing wind sails for ships for high-efficiency/low energy consumption transportation of cargo and passengers,
cardboard products (boxes, containers, etc.)

To produce a sandwich panel according to the present invention, the method comprises the following steps:
a) either the front face plate or the back face plate are positioned with an outer surface downwards;
b) the upwards facing surface of the face plate is provided with an adhesive;
c) the core materials or the core inserts or the patch cores or a combination of these are placed upon the upwards facing surface and adhered together;
d) the upwards facing surface of the core materials or said core inserts or the patch core or a combination of these are provided with an adhesive; and
e) the front face plate or the back face plate is positioned upon the upwards facing surface.

Alternatively, the sandwich panel can be produced with the wanted core material according to the aforementioned method, followed by a step where holes are cut in either of the face plates and through the core materials, upon which the cut “plugs” of the core material are removed and replaces with either another core material or core insert.

If the sandwich panel is provided with reinforcing patches, the aforementioned method is provided with a step by which the reinforcing patches are applied to the joints between the materials and/or core inserts.

### BRIEF DESCRIPTION OF THE DRAWINGS

The invention will be described in more detail below with reference to the accompanying drawing in which

FIG. 1 shows a conventional design of reinforcing inserts in a sandwich panel, and a fading out of a sandwich panel to a monolith;

FIG. 2 shows a conventional design of joints of various cores in a sandwich panel;

FIG. 3 shows different types of core joints in a sandwich panel according to the invention;

FIG. 4 shows a conventional design of a stiffener/backing plate in a sandwich panel;

FIG. 5 shows different designs of inserts (stiffener/backing plate) according to the invention;

FIG. 6 shows a conventional design of joints of various cores in a sandwich panel;

FIG. 7 shows different designs of types of core joints with reinforcing patches according to the invention;

FIG. 8 shows a sketch of a sandwich panel being centrally loaded and analyzed by means of the Finite Element Analysis;

FIG. 9 shows a graph of the distribution of the normal stresses in the front and back face plates of the sandwich panel along the joint of two core materials where the joint is situated at a distance of 120 mm from the center of the panel;

FIG. 10 shows a graph of the distribution of the transverse normal stresses in the core at the upper (front) and lower (back) face-core interfaces, where the joint is situated at a distance of 120 mm from the center of the panel;

FIG. 11 shows a sketch of central loading of sandwich panels having a conventional 90 degrees joint, and central loading of sandwich panels having reinforcing patches;

FIG. 12 shows a graph of load versus displacement for two types of sandwich panels;

FIG. 13 shows a conventional design of a fading out of a sandwich plate to a monolith according to the invention;

FIG. 14 shows different designs of a fading out of a sandwich plate to a monolith according to the invention;

FIG. 15 shows a sandwich plate with four different types of core joints used in the experimental study and zooms in on the central diaphragm, and reinforcement patch are also shown; and

FIG. 16 shows an experimental set up for fatigue testing of a sandwich plate.

### DETAILED DESCRIPTION OF THE INVENTION

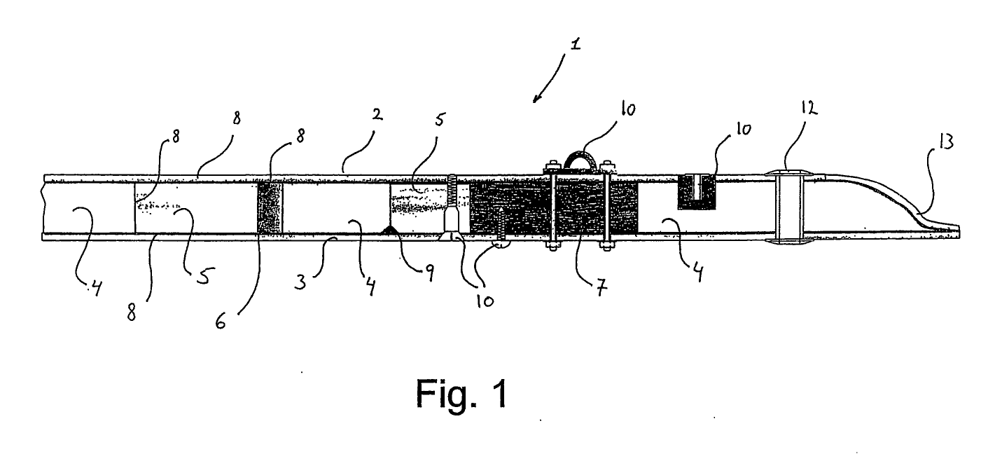

FIG. 1 shows a conventional design a sandwich panel 1, a front face plate 2, a back face plate 3 and one or more core materials 4, 5, where the front face plate 2 and the back face plate 3 are interconnected by the core materials 4, 5.

The core materials 4, 5, the patch core 6 and core inserts 7 are connected together and/or to the front face plate 2 and the back face plate 3 with an adhesive layer 8.

Between the end surfaces of core material 4, 5 reinforcing patches 9 are placed which locally reinforce either the front face plate 2 or the back face plate 3.

Different types of fasteners 10 are shown that are applied in the sandwich panel 1 for attachment or rigging purposes for different appliances, such as engines, masts, cable ducts, or the like.

It is shown how a fastener 10 is applied in a filler cavity 11, how a through-the-thickness insert 12 is applied in the core material 4, and how a fading out of the sandwich panel 1 to a monolith 13 may take place.

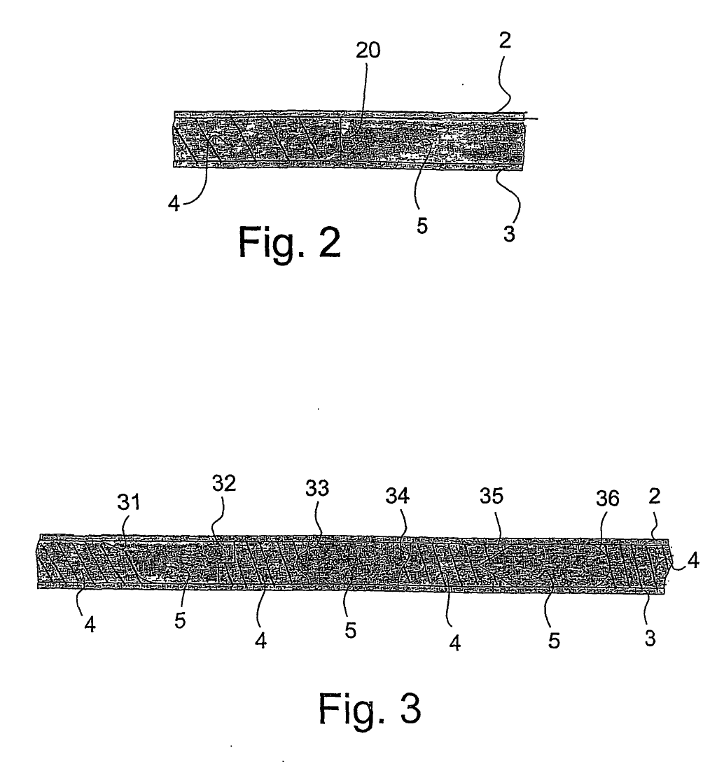

FIG. 2 shows a conventional design of a joint 20 between the first core material 4 and the second core material 5. The joint 20 is formed in one part, which is linear and runs from the front plate 2 to the back plate 3 at an angle of 90 degrees in relation to the front plate 2 and the back plate 3.

FIG. 3 shows different types of joints 31, 32, 33, 34, 35, 36 between the first core material 4 and the second core material 5 where the joints 31, 32, 33, 34, 35, 36 all run from the front plate 2 to the back plate 3, and at least on one part terminate at an angle different from 90 degrees in relation to said front plate 2 and said back plate 3.

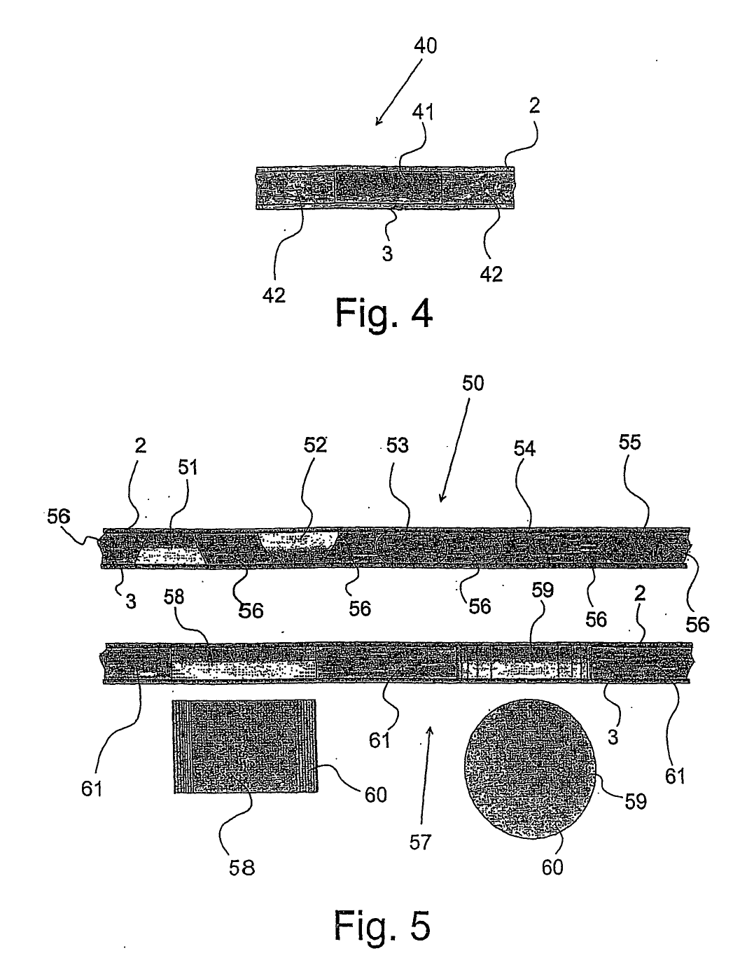

FIG. 4 shows a conventional design of a sandwich panel 40 with an insert in the form of a stiffener/backing plate 41 placed between the front plate 2 and the back plate 3 and between two parts of the core material 42 and with end surfaces that terminate at an angle of 90 degrees in relation to the front plate 2 and said back plate 3.

FIG. 5 shows a sandwich panel 50 with different designs of inserts (stiffeners/backing plates) 51, 52, 53, 54, 55 placed between the front plate 2 and the back plate 3 and between parts of the core material 56 and with end surfaces that terminate at angles different from 90 degrees in relation to said front plate 2 and said back plate 3.

FIG. 5 furthermore shows a sandwich panel 57 with different designs of inserts (stiffeners/backing plates) 58, 59 placed between the front plate 2 and the back plate 3 and between parts of the core material 61 and with apertures 60 in the boundary area of the inserts (stiffeners/backing plates) 58, 59.

Insert 58 is a square stiffener/backing plate where the apertures 60 are positioned in rows transversely and preferably parallel to the surface of the front plate 2 and the back plate 3.

Insert 59 is a circular stiffener/backing plate where the apertures 60 are positioned radially in rows and preferably run through the thickness of the insert 59.

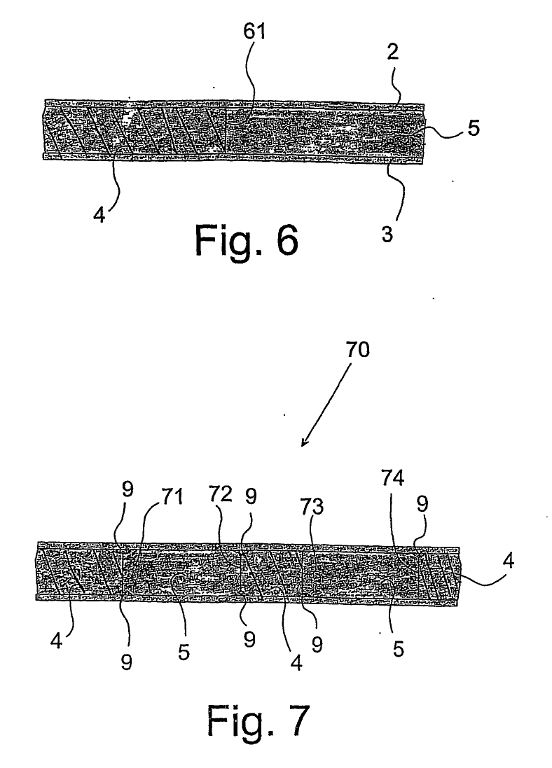

FIG. 6 shows a conventional design of a joint 61 between the first core material 4 and the second core material 5. The joint 61 is formed in one part that is linear and runs from the front plate 2 to the back plate 3 at an angle of 90 degrees in relation to the front plate 2 and the back plate 3.

FIG. 7 shows a sandwich panel 70 with different types of core joints 71, 72, 73, 74 between parts of core materials 4, 5 where each of the core joints 71, 72, 73, 74 is provided with at least one reinforcing patch 9.

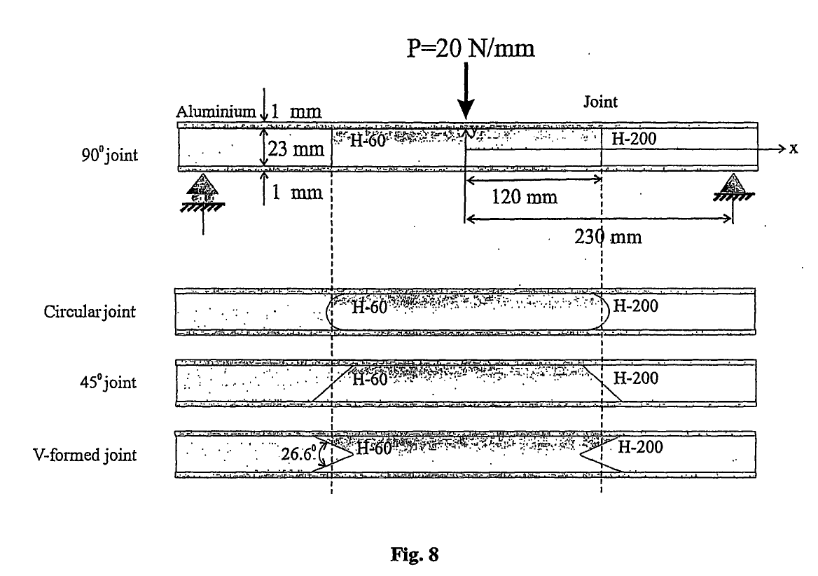

The following description of examples relates to FIGS. 8-12.

### EXAMPLE 1

### Finite Element Analysis of the Stresses in the Vicinity of Joints of Different Core Materials in Sandwich Panels

The sandwich panel shown in FIG. 8 consists of two aluminium face plates and two types of PVC core materials, i.e. Divinycell H60 and Divinycell H200 (DIAB AB Group).

Divinycell H60 constitutes the middle part of the panel, while Divinycell H200 constitutes its edges. The mechanical characteristics of the panel constituents are given in the table below.

| | | |
|---|---|---|
| Modulus of elasticity of aluminium face plates | 70 | GPa |
| Modulus of elasticity of a softer core, Divinycell H60 | 60 | MPa |
| Modulus of elasticity of a stiffer core, Divinycell H200 | 290 | MPa |

The panel is simply supported at its ends and centrally loaded with a force P=20 N/mm.

Various shapes of the core joints are considered as illustrated in FIG. 8. They are a conventional 90 degrees joint as well as circular, 450 and V-formed joints.

The largest bending moment is in the middle of the panel at x=0 and decreases linearly to the edges (where x=230 mm). If local effects in the vicinity of joints of different core materials are disregarded, the same behavior for the normal stresses in the face plates of the panel would be expected: the face stresses are highest in the middle and decrease linearly to zero at the edges of the panel.

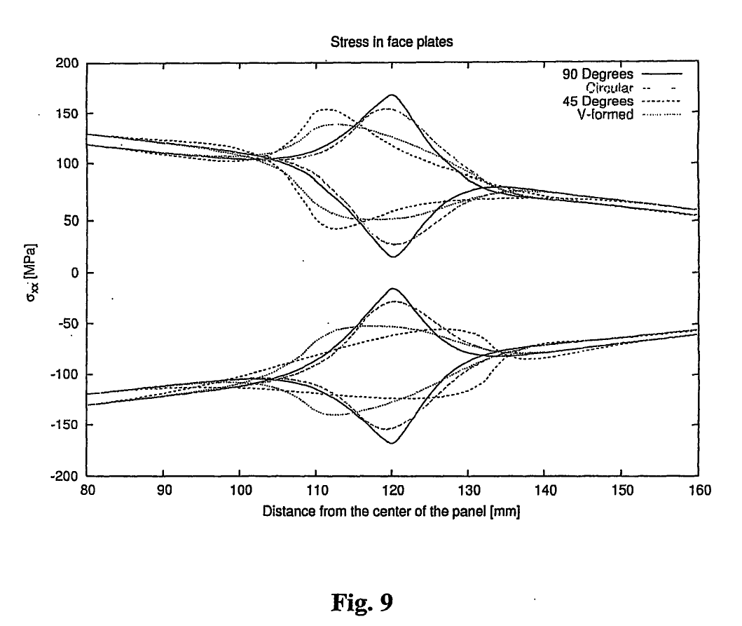

FIG. 9 illustrates calculated stresses in the upper loaded (front) and lower (back) face plates in the vicinity of the joint situated at a distance of 120 mm from the loading point. Note that the front face is in compression (lower family of curves in FIG. 9) and the back face is in tension.

For each face plate there are two curves: one describes the stresses at the outer surface of the face, and the second describes the stresses at the facecore interface. The difference between the outer and inner stresses is not large because of a fairly thin thickness of each face plate, but this tendency is violated at the core joints where local peaks of the face stresses are observed.

According to the classic approach one would expect stresses σₓₓ˜±100 MPa at distance of 120 mm, but they achieve values of ±170 MPa due to the discrepancy between the elastic properties of the cores at the joint.

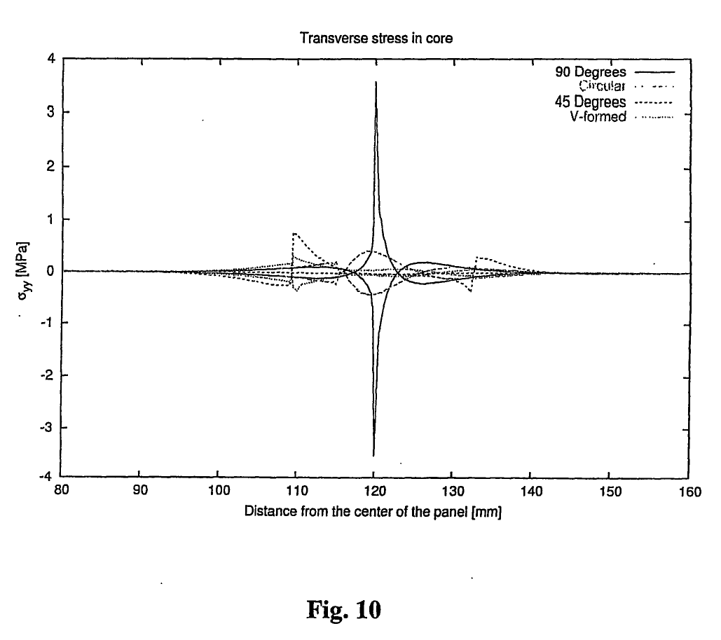

Similar local effects are present in the core of the panel, the most conspicuous of these being the normal stresses occurring in the core when different core materials are joined together. This is shown in FIG. 10 with regard to the upper and lower face-core interfaces. The joints of different cores give rise to transverse normal stresses in the core that would be completely absent in a panel having a uniform core.

Note that in areas far from the joint, both in the soft and stiff cores, i.e. x<95 mm and x>145 mm, the transverse stresses are eliminated.

The transverse normal stresses in the core constitute a very critical point in the sandwich panel because they may initiate a delaminating of the face plate and the core, which will jeopardize the integrity of the structure.

The shape of the joint has a very large effect on the maximum value of the normal stresses in the core, as illustrated in FIG. 10.

Both a wedge joint of 26.6 degrees and a circular joint allow the maximum value of σ_{yy} to be no larger than 0.5 MPa, which is 7 times smaller than the maximum stress of 3.6 MPa in the conventional 90 degrees joint.

### EXAMPLE 2

### Experimental Study of the Maximum Strength of Sandwich Panels with 90 Decrees Joints and Sandwich Panels with Reinforcing Patches in the Joints

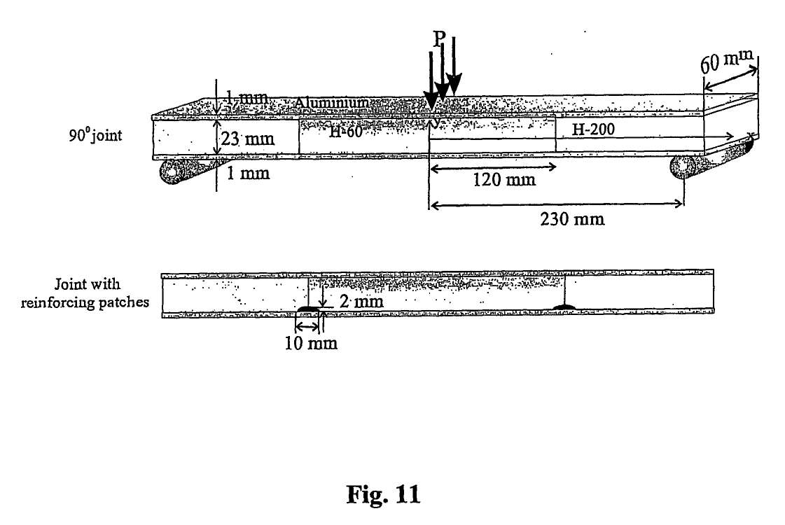

Two types of sandwich panels were experimentally studied in a static three-point bending, one panel having a 90 degrees joint and the second panel having a 90 degrees joint with reinforcing patches, cf. FIG. 11.

Face plates made of aluminium 7075-T6 (Aluminium Company of America). Divinycell H60 constitute the middle part of the panel, while Divinycell H200 (DIAB AB Group) makes up its edges.

All geometric parameters of the panels are given in FIG. 11. Their mechanical characteristics appear from the table above.

Two-component epoxy resin adhesive system Araldite® 2000 (Huntsman Advanced Materials) was used both for the attachment of the face plates to the core, and for adjoining different core materials at the joints.

Reinforcing patches were produced by machining segment-like grooves at the joints and by filling them with the same adhesive.

In the experiment, the panels were subjected to a central load P until they broke. Loading velocity was 0.05 mm/sec.

Three panels of each type were manufactured, and their maximum strength was assessed by recording the applied load and displacement of the central part of the panel.

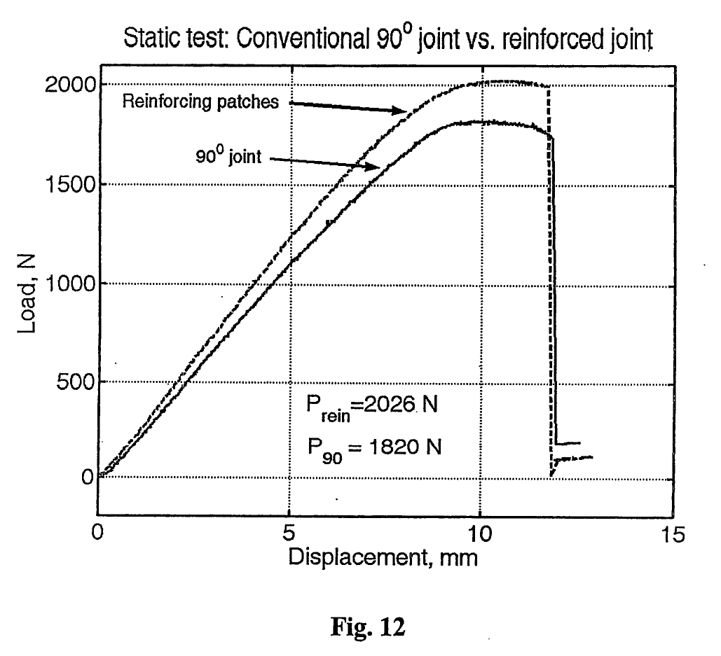

The average characteristics of the panels having 90 degrees joints and the panels having reinforced joints are shown in FIG. 12.

The maximum critical load for the panel with reinforced joints is approximately 10% higher than is the case for a conventional panel

It should be mentioned that the fracture in the case of the panels having a 90 degrees joint always started from the joint, while the presence of the reinforcing patches forced fractures to start in the softer core material and at higher loads.

This proves that the junction is a vulnerable element in a sandwich structure, but it can be reinforced by simple local strengthening of the faces at the spots neighborhood the core joints.

Note that shape and dimensions of the reinforcing patches were not optimized. This can be done by using for example Finite Element Analysis, whereby the static critical strength of the sandwich panel can be further increased.

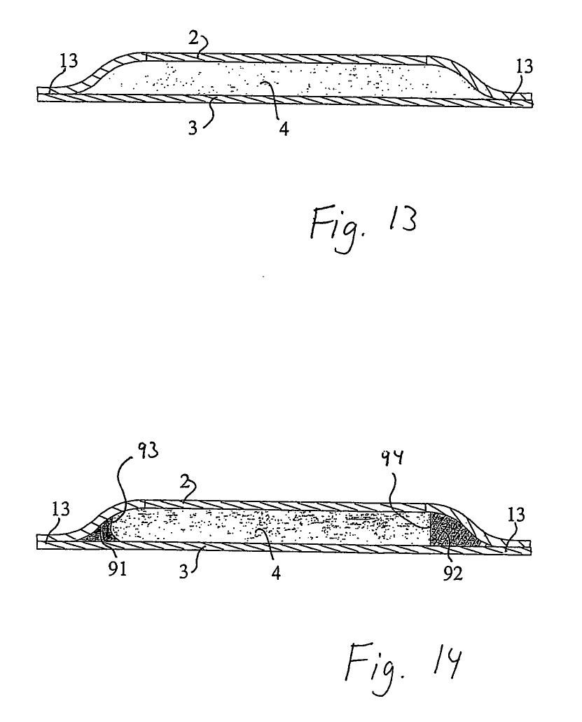

FIG. 13 shows a conventional design of a fading out of a sandwich panel 1, where front plate 2 fades out to a monolith 13, where front plate 2 and back plate 3 meet. Only one type of original core material 4 is used throughout the whole sandwich panel 1.

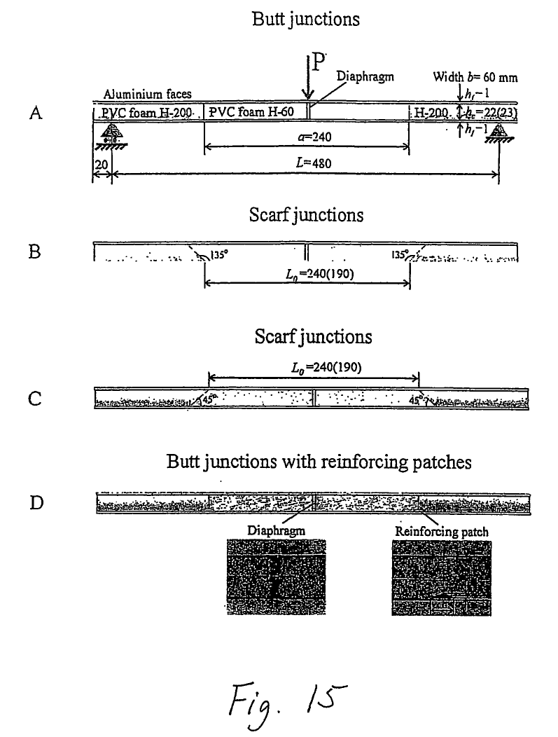

FIG. 14 shows a sandwich panel 1, where front plate 2 fades out to monoliths 13, where front plate 2 and back plate 3 meet. The end zones, where the front plate 2 fades out and the front plate 2 and back plate 3 meet, contains reinforcements patches 91,92 of a stronger core material, the core material 4 and with different types of junctions 93, 94.

The following description of example 3 relates to FIG. 15, which shows a sandwich plate with four different types of core joints used in the experimental study and zooms in on the central diaphragm and reinforcement patch are also shown, and

### EXAMPLE 3

### Experimental Study of the Fatigue Endurance of the Sandwich Panels with Conventional and Modified Joints

Four types of sandwich panels were experimentally studied in a dynamic three-point bending, one panel having a 90 degrees joint (type A—butt junction), the second panel having a 135 degrees joint (type B—scarf junction), the third panel having a 45 degrees joint (type C—scarf junction), and the fourth panel having a 90 degrees joint with reinforcing patches (type D—butt junction with reinforcing patches), cf. FIG. 15.

Face plates were made of aluminum 7075-T6 (Aluminium Company of America). Divinycell H60 constituted the middle part of the panels, while Diviny-cell H200 (DIAB AB Group) made up their edges.

All geometric parameters of the panels are given in FIG. 15. Their mechanical characteristics appear from the table above.

Two-component epoxy resin adhesive system Araldite® 2000 (Huntsman Advanced Materials) was used both for the attachment of the face plates to the core, and for adjoining different core materials at the joints.

Reinforcing patches were produced by machining segment-like grooves at the joints and by filling them with the same adhesive.

Each panel was furnished with the central diaphragm of a stiff material (molded epoxy resin), which prevented squashing of the panel under the applied central load, cf. zoom in FIG. 15.

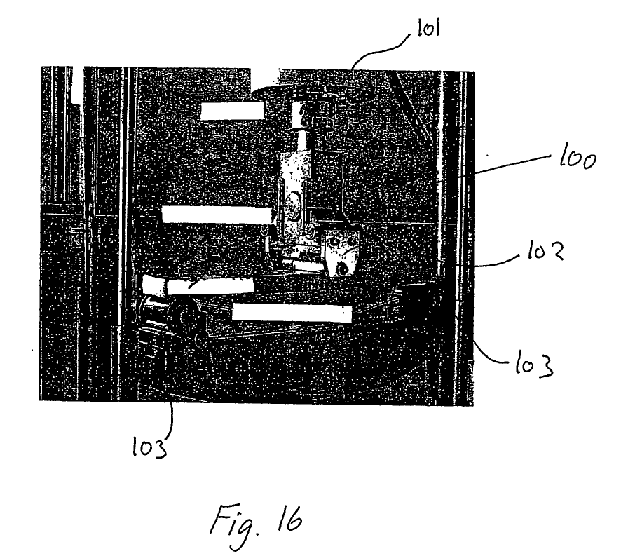

In the experiment, each four group of the panels was subjected to a repetitive central load P=1.4 kN, which equals to the 70% of the critical static load for these panels. The load was sinusoidal with the R-ratio=0.1 and frequency of 3 Hz. The experimental set-up for the three-point loading is shown in FIG. 16.

The number of cycles for each panel endured before failure was monitored, and these are presented in the table below. The fatigue life of the scarf and reinforced butt joints is substantially increased as it follows from the table, which means that the structural performance of the sandwich panels with the modified joints is higher than this of the panels with the conventionally designed joints.

| | | | | Reinforced |
|---|---|---|---|---|
| | Butt junction A | Scarf junction B | Scarf junction C | junction D |
| Number | 7 | 8 | 7 | 6 |
| of | | | | |
| tested | | | | |
| panels | | | | |
| Number | {30, 75, 20, 33, 9, | {86, 50, 37, 27, 26, | {65, 13, 37, 45, 35, | {31, 22, 56, 47, |
| of cycles | 17, 31} | 13, 15, 17} | 24, 31} | 54, 45} |
| for | | | | |
| the | | | | |
| group × 1000 | | | | |
| Sample | 30758 | 33909 | 35613 | 42448 |
| mean, | 8171 | 8578 | 6269 | 544 |
| cycles | | | | |
| Error of | | | | |
| mean, | | | | |
| cycles | | | | |
| Confidence | 30758 ± 15862 | 33909 ± 16255 | 35613 ± 12180 | 42448 ± 1096 |
| interval | | | | |
| 95% | | | | |
| Increase | | 10% | 16% | 38% |
| of fatigue | | | | |
| life | | | | |
| comparing | | | | |
| to | | | | |
| conventional | | | | |
| design | | | | |

The experiment proves that the joint, which is a vulnerable element in a sandwich structure, can be reinforced by shaping a core joint in a different way or by local strengthening of the faces at the spots neighboring the core joints.

Note that shape of the core joints and dimensions of the reinforcing patches were not optimized. This can be done by using for example Finite Element Analysis, whereby the fatigue life of the sandwich panels under repetitive loading can be further increased.

FIG. 16 shows an experimental set up for fatigue testing of a sandwich plate, where the rig 100 compromises a load cell 101 connected to a loading wedge 102, which rest upon sandwich panel 1, which is placed on supporting rollers 103.

Materials of the Invention

Below follows examples of materials suitable for use with the invention.

Non-exclusive list of widely used types of face plate materials:
1 Steel and steel alloys
2 Stainless steel
3 Aluminium and its alloys
4 Titanium and its alloys
5 Plywood
6 Polymer materials
7 Polymer-based fiber-reinforced materials
8 Glass-fiber reinforced polymers (so-called GFRPs)
9 Carbon-fiber reinforced polymers (so-called CFRPs)
10 Aramid (Kevlar)-fiber reinforced polymers
11 Fiber-reinforced polymers with combinations of the fiber types and systems mentioned above (so-called hybrid composite materials)

The polymer-based fiber-reinforced materials mentioned are provided by a large number of different manufactures under a very large number of names and trade marks. In addition, the aforementioned fibrous composite materials systems can be manufactured using several fundamentally different manufacturing/processing techniques including hand lay-up, prepreg technology and various resin molding transfer (RTM) and vacuum-assisted resin molding transfer (VARTM) techniques.

Examples of commercially available face plate composite material systems;
1 Glass-fiber reinforced laminates (fabrics/mats) from Ahistrom Corp.
2 Prepregs (reinforced Aramid, Carbon, Glass fibers/fabrics into which a pre-catalyzed resin system has been impregnated by a machine) from SP Systems.
3 SPRINT® glass and carbon fiber composite systems from SP Systems.
4 Prepreg systems with carbon, aramid or glass-fiber embedded in epoxy, phenolic, bismaleimide (BMI) or cyanate polymer resins from Hexcel Composites.
5 Prepreg and fiber (carbon/graphite, glass, aramid) and resin material (epoxy, phenolic, thermoplastic) systems from Owens Corning.

Non-exclusive list of widely used types of core materials:
1 Aluminium honeycomb core materials.
2 Aramid honeycomb core materials.
3 Polymeric foam core materials including:
   4 Cross-linked and linear PVC foams.
5 Polymethacrylimide (PMI) foams.
6 Polyurethane foams.
7 Balsa wood core materials.

Examples of commercially available sandwich core materials:
1 Divinycell®, Klegecell®, PVC and polyurethane polymers based foams from DIAB AB Group.
2 ProBalsa®, end-grain balsa woods from DIAB AB Group.
3 CoreCell®, styreneacrylonitrile polymer based foams from SP Systems.
4 Durakore™, SuperLite™—end-grain balsa wood from Alcan Airex Baltek Corp.
5 Rohacell® PMI foam core from Rohm GmbH & Co. KG.
6 HexWeb® aluminium honeycomb core materials from Hexcel Composites.
7 Nomex® aramid honeycomb core materials from DuPont.
8 PAMG-XR1 5052, 5056, 3003, aluminium honeycomb core from PLASCORE.
9 PP30, PP40, polypropylene honeycomb core from PLASCORE.
10 DUFAYLITE, paper honeycomb from DUFAYLITE.
11 TRICEL, phenolic resin impregnated paper honeycomb from TRICEL Honey-comb Corp.
12 Lantor Coremat, nonwoven core from Lantor BV.

Non-exclusive list of widely used types of structural adhesives:
1 Epoxy
2 Polyurethane
3 Polyester
4 Cyanoacrylate
5 Phenolic
6 Acrylic.

Structural adhesive materials systems are provided from a very large number of manufacturers that produce and market an even larger number of commercial adhesive systems based on many different polymers systems and technologies.

Examples of commercially available adhesive material systems:
1 Araldite® epoxy-based adhesive systems from Huntsman Advanced Materials.
2 Redux® vinyl phenolic and epoxy-based adhesive systems from Hexcel Composites.
3 CORE-BOND®, POLY-BOND®, POLY-FAIR®, polyester-based from SP Systems.
4 Pro-Bond, Divilette®, polyester-based from DIAB AB Group.
5 SUPRASEC® and DALTOREZ®, polyurethane-based from Huntsman Advanced Materials (under the names JEFFOL® and RUBINATE® in America).
6 Methacrylate based adhesives from EpoxySystems™.
7 SikaFlex® and SikaForce® polyurethane adhesives from Sika AG.
8 FM-series® of epoxy-based adhesive film systems from American Cyanamide.
9 3MTM product range of acrylic-based structural adhesives from SysCon Technology Inc.

1. A sandwich panel including a front face plate, a back face plate, and one or more core materials where the front face plate and the back face plate are interconnected by the core materials of a variable thickness, comprising a number of different core inserts, fading outs of a sandwich panel to a monolith, and/or fasteners provided in connection the sandwich panel, where boundaries between the core inserts and/or fasteners and the core material terminate at an angle, in relation to the face plates and/or where a number of joints , shaped by complementary surfaces of the core materials, terminate at an angle , in relation to the face plates and when the core materials and/or a the core inserts are provided with a structural grading and/or shaping of said boundaries and/or the joints

2. A sandwich panel according to claim 1, wherein the boundaries and/or the joints, at least on one part, terminate at an angle different from 90 degrees in relation to the face plates.

3. A sandwich panel according to claim 2, wherein the angle is varied throughout the thickness of said core materials and/or the core inserts.

4. A sandwich panel according to claim 1, wherein the core materials and/or the core inserts are provided with a number of apertures.

5. A sandwich panel according to claim 1, wherein the core material furthermore comprises one or more patch cores, and where boundaries between the patch cores and the core material terminate at an angle different from 90 degrees in relation to the face plates.

6. A sandwich panel according to claim 1, wherein the joint of the core materials are provided with one or more reinforced patches that are connected to one of either the face plates.

7. A sandwich panel according to claim 1, wherein the fading out of the sandwich panel to a monolith is provided with a stiffer core and/or core patch with a sharpening of the boundaries of the core or core patch.

8. A method for producing a sandwich panel comprising:
a) positioning either a front face plate or a back face plate with an outer surface downwards;
b) providing the upwards facing surface of the face plate with an adhesive;
c) placing the core materials or he core inserts or the patch cores or a combination thereof upon the upwards facing surface and adhered together;
d) providing the upwards facing surface of the core materials or the core inserts or the patch core or a combination thereof of these with an adhesive;
e) positioning the front face plate or the back face plate upon the upwards facing surface; and
f) a whole sandwich panel is pressed together.

9. A sandwich panel in accordance with claim 7 wherein: the angles are 90°

10. A sandwich panel in accordance with claim 2 wherein: the angles are 90°

11. A sandwich panel in accordance with claim 3 wherein: the angles are 90°

12. A sandwich panel in accordance with claim 4 wherein: the angles are 90°

13. A sandwich panel in accordance with claim 5 wherein: the angles are 90°

14. A sandwich panel in accordance with claim 6 wherein: the angles are 90°

15. A sandwich panel in accordance with claim 7 wherein: the angles are 90°

16. A sandwich panel in accordance with claim 8 wherein: the angles are 90°
